(19) United States
(12) Patent Application Publication
(10) Pub. No.: US 2025/0270360 A1
(43) Pub. Date: Aug. 28, 2025

(54) COMPOSITIONS INCLUDING ORGANOSILICONE POLYMER AND AQUEOUS PHASE FILM FORMER

(71) Applicant: L'OREAL, PARIS (FR)

(72) Inventors: Yixin YANG, UNION, NJ (US); Treasure BELLAMY, COLONIA, NJ (US); Brady ZARKET, EDISON, NJ (US)

(73) Assignee: L'OREAL, PARIS (FR)

(21) Appl. No.: 18/588,436

(22) Filed: Feb. 27, 2024

(51) Int. Cl. C08F 226/10; C08F 220/26

(52) U.S. Cl. CPC C08F 226/10; C08F 220/26

(57) ABSTRACT

The invention relates to compositions including (a) water, (b) at least one oil, (c) at least one organosilicone polymer selected from a silicone acrylate copolymer, a glycerolated silicone resin and combinations thereof; and (d) at least one aqueous phase film former, such as a copolymer including a vinyl pyrrolidone monomer. Methods of making up skin are also provided.

### FIELD OF THE INVENTION

The present invention relates to oil-in-water (o/w) emulsions (compositions) comprising at least one organosilicone polymer and at least one aqueous phase film former, as well as to methods and kits comprising such emulsion compositions in container(s) or in application. The compositions have beneficial cosmetic properties including, for example, as primer or setter compositions for good or improved wear, water and/or sebum resistance, and/or transfer resistance properties of separately applied compositions.

### DISCUSSION OF THE BACKGROUND

At the present time on the market for caring for and making up keratin materials, many products claim staying power throughout the day, withstanding external factors such as water, sebum, mechanical friction, etc. (waterproof mascara, food-proof lipsticks, long-lasting foundations). Long-lasting products for the lips, the eyelashes, the eyebrows or the face, which can be used at home, are mainly based on synthetic coating polymers in the presence of solvent.

One particular application, makeup “setting” is traditionally accomplished by spraying a composition including a water-soluble polymer over makeup that had been previously applied to e.g., the face. Traditional makeup setters, however, often do not greatly improve the wear of the of the underlying makeup and its resistance to external forces such as mechanical friction, water, sweat and perspiration, sebum and/or oil. The instant inventors have recognized the need for improved materials and compositions in this regard.

### SUMMARY OF THE INVENTION

The present invention relates to oil-in-water emulsion compositions including (a) water, (b) at least one oil, (c) at least one organosilicone polymer selected from a silicone acrylate copolymer, a glycerolated silicone resin and combinations thereof; and (d) at least one aqueous phase film former, such as a copolymer including a vinyl pyrrolidone monomer.

According to certain embodiments the compositions include a copolymer of N-vinyl pyrrolidone, methacrylamide, and N-vinylimidazole. According to certain other embodiments, the compositions are in the form of a gel. According to certain other embodiments, the compositions further includes (e) at least one compound selected from the group consisting of at least one gelling agent, at least one colorant, at least one active agent, and mixtures thereof. According to certain other embodiments, at least two of gelling agent, colorant and active agent are present in the composition. According to certain other embodiments, the at least one organosilicone polymer is or includes a silicone acrylate copolymer. According to certain other embodiments, the at least one organosilicone polymer is or includes a glycerolated silicone resin. According to certain other embodiments, the (c) at least one organosilicone polymer selected from a silicone acrylate copolymer, a glycerolated silicone resin and combinations thereof; and the (d) at least one copolymer comprising a vinyl pyrrolidone monomer are present in a weight ratio, (c):(d) that is from about 0.5:1 to about 3:1. According to certain other embodiments, the composition is devoid of colorant. According to certain other embodiments, the compositions include one, more than one or even all of the limitations described in this paragraph.

According to another aspect of the invention, a method of making up skin includes applying to skin having a makeup film formed thereon, a composition including (a) water, (b) at least one oil, (c) at least one organosilicone polymer selected from a silicone acrylate copolymer, a glycerolated silicone resin and combinations thereof; and (d) at least one aqueous phase film former (such as any of those compositions described above). The present invention also relates to methods of setting a color cosmetic composition (e.g., composition containing colorant such as a foundation) by applying any of the above-described compositions to a color cosmetic composition previously-applied to keratinous material in an amount sufficient to obtain setting of the previously-applied color cosmetic composition to keratinous material.

It is to be understood that both the foregoing general description and the following detailed description are exemplary and explanatory only and are not restrictive of the invention.

### DETAILED DESCRIPTION OF THE INVENTION

In the following description of the invention and the claims appended hereto, it is to be understood that the terms used have their ordinary and accustomed meanings in the art, unless otherwise specified.

Other than in the operating examples, or where otherwise indicated, all numbers expressing quantities (e.g., concentrations, ratios, and the like) of ingredients and/or reaction conditions are to be understood as being modified in certain embodiments by the term “about,” meaning within 10% to 15% of the indicated number (e.g. “about 10%” means 8.5% to 11.5% such as 9% to 11%, and “about 2%” means from 1.7% to 2.3 such as from 1.8% to 2.2%).

Similarly, for ratios, the modifier “about” means within 10% or 15% of the number. For example, about 4:1 means from 3.4:1 to 4.6:1, preferably 3.6:1 to 4.4:1. As readily understood by one skilled in the art, where the first ingredient in a ratio is less than the second, then a ratio may be expressed “inversely.” For example, if a second ingredient, B is present in an amount or concentration that is 2.5 times greater than that of ingredient A, this may be identified as an A:B ratio of 1:2.5. “About 1:10,” means from 1:8.5 to 1:11.5, preferably 1:9 to 1:11. Unless otherwise indicated, all concentrations shown as percentages are concentrations by weight and also, unless otherwise indicated, relate to the entire cosmetic adhesive composition as a whole.

“A” or “an” as used herein means “at least one.”

“At least one” means one or more and thus includes individual components as well as mixtures/combinations.

Numerical ranges are inclusive of endpoints and meant to include all combinations and sub-combinations. For example, from about 5%, 10% or 15% to about 20%, 50% or 60% may refer to about 5% to about 20%, about 5% to about 50%, about 5% to about 60%, about 10% to about 20%, about 10% to about 50%, about 10% to about 60%, about 15% to about 20%, about 15% to about 50%, or about 15% to about 60%. As used herein a range of ratios is meant to include every specific ratio within, and combination of subranges between the given ranges.

“Film former”, “film-forming polymer” or “film-forming agent” as used herein means a polymer or resin that leaves a film on the substrate to which it is applied, for example, after a solvent accompanying the film former has evaporated, absorbed into and/or dissipated on the substrate.

“Wax” as used herein is a lipophilic fatty compound that is solid at ambient temperature (25° C.) and changes from the solid to the liquid state reversibly, having a melting temperature of more than 30° C. and, for example, more than 45° C., and a hardness of more than 0.5 MPa at ambient temperature.

“Surfactant” and “emulsifier” are used interchangeably throughout this specification.

“Substituted” as used herein, means comprising at least one substituent. Non-limiting examples of substituents include atoms, such as oxygen atoms and nitrogen atoms, as well as functional groups, such as hydroxyl groups, ether groups, alkoxy groups, acyloxyalky groups, oxyalkylene groups, polyoxyalkylene groups, carboxylic acid groups, amine groups, acylamino groups, amide groups, halogen containing groups, ester groups, thiol groups, sulphonate groups, thiosulphate groups, siloxane groups, and polysiloxane groups. The substituent(s) may be further substituted.

“Volatile”, as used herein, means having a flash point of less than about 115° C.

“Non-volatile”, as used herein, means having a flash point of greater than about 115° C.

“Polymer” as used herein means a compound which is made up of at least two monomers.

“Matte” in compositions as used herein refers to compositions having little to no light reflection. For example, matte compositions can have average gloss properties, measured at 60°, of less than or equal to 10, for example 9, preferably less than or equal to 8, 6, 5, 4 or 1, including all ranges and subranges therebetween such as 1-10, 1-5, 2-10, 3-8, less than 1, less than 3, less than 5, etc. Such measurements can be made by depositing films to be tested onto a substrate (ex. a black scrub panel P121-10N or opacity card BYK No. 2810) using a drawdown bar (for example, of 1 mil, 3 mil, or 6 mil thickness) and an Automatic Drawdown Machine. The films can then be dried at room temperature and analyzed using a gloss meter (BYK: micro-TRI-gloss) at an angle of 60°.

“Free” or “substantially free” or “devoid of” as it is used herein means that while it is preferred that no amount of the specific component be present in the composition, it is possible to have very small amounts of it in the compositions of the invention provided that these amounts do not materially affect at least one, preferably most, of the advantageous properties of the conditioning compositions of the invention. Thus, for example, “free of colorant” means that an effective amount (that is, more than trace amounts) of colorant is omitted from the composition, “substantially free of colorant” means that colorant is present in amounts not greater than 0.1% by weight, and “devoid of colorant” means that colorant is present in amounts not greater than 0.25% by weight, based on the total weight of the composition. The same nomenclature applies for all other ingredients identified throughout the application and in this paragraph such as, for example, silicone oils (compositions of the invention which are “free of silicone oils,” “substantially free of silicone oils,” and “devoid of silicone oils” have meanings consistent with the discussion within this paragraph), even if not specifically discussed for each identified ingredient. Thus, for example, “free of phenylated silicone oil” means that an effective amount (that is, a matte-inhibiting effective amount) of phenylated silicone oil is omitted from the composition (that is, about 0% by weight), “substantially free of phenylated silicone oil” means that phenylated silicone oil is present in amounts not greater than 0.25% by weight, and “devoid of phenylated silicone oil” means that phenylated silicone oil is present in amounts not greater than 0.5% by weight, based on the total weight of the composition. The same nomenclature applies for all other ingredients identified throughout the application and in this paragraph such as, for example, (1) mattifying fillers (compositions of the invention which are “free of mattifying fillers,” “substantially free of mattifying fillers,” and “devoid of mattifying fillers,”) and (2) additional film formers other than hydrophobically-modified polysaccharide compound and aqueous phase film former (compositions of the invention which are “free of additional film formers,” “substantially free of additional film formers,” and “devoid of additional film formers”) have meanings consistent with the discussion within this paragraph, even if not specifically discussed for each identified ingredient. Discussed examples of the use of such language such as those in this paragraph are intended to be exemplary, not limiting.

“Makeup Result” as used herein, refers to compositions where color remains the same or substantially the same as at the time of application, as viewed by the naked eye, after an extended period of time. “Makeup Result” may be evaluated by evaluating long wear properties by any method known in the art for evaluating such properties. For example, long wear may be evaluated by a test involving the application of a composition to keratin materials such as lips and evaluating the color of the composition after an extended period of time. For example, the color of a composition may be evaluated immediately following application to keratin materials such as lips and these characteristics may then be re-evaluated and compared after a certain amount of time. Further, these characteristics may be evaluated with respect to other compositions, such as commercially available compositions.

“Keratinous material” or “keratin material” means natural nails, lips, skin such as the face, the body, the hands, and the area around the eyes, and keratin fibres such as head hair, eyelashes, eyebrows, bodily hair of a human, as well as synthetic additions such as false eyelashes, false eyebrows, false nails, etc.

“Physiologically acceptable” means compatible with keratinous material and having a pleasant color, odor and feel, and which does not cause any unacceptable discomfort (stinging or tautness) liable to discourage a consumer from using the composition. Compositions of the present invention may be in the form of a gel composition.

“Gel composition” means a composition which does not flow similar to a liquid when applied to a substrate, a composition which has a 3-dimensional network that inhibits the composition from spreading on, or dripping from, a substrate after application owing to gravity over a short period of time (e.g., less than 10 seconds). G′ (storage modulus) is higher than G″ (loss modulus) at all range of strains up to 300% strain. Preferably, G′ (storage modulus) is higher than G″ (loss modulus) at low strain, but with G′ decreasing and G″ increasing, and the gel has the crossover point at >0.1% strain, preferably >1% strain, and preferably less than 200% strain, preferably less than 150% strain.

“Gel Crossover Point” (Sol/Gel Point), means the point at which the G″ (loss modulus) intersects the G′ (storage modulus), reported in % strain. It is the point at which a composition goes from a more solid state to a more liquid state. An example of a method for determining gel crossover point is as follows: G″ (loss modulus) and G′ (storage modulus) using a Discovery HR-3 Rheometer by TA Instruments, having 40 mm parallel plate geometry on a stainless steel flat peltier plate. The test can be run @ 25° C., with test parameter of angular frequency of 1.0 rad/s and logarithmic sweep: Strain % 0.01 to 1000.0%. 5 points per decade. Results reported in % strain.

“Natural compound” refers to any compound derived directly from a natural substance such as a plant without having undergone any chemical modification.

“Compound of natural origin” refers to any compound derived from a natural compound which has undergone one or more chemical modifications, for example by organic synthesis reaction, without the properties of the natural compound having been modified.

“Synthetic compound” refers to any compound which is not a natural compound or a compound of natural origin.

“Room temperature” means 25° C.

“Atmospheric pressure” means 760 mmHg, i.e. 105 pascals.

The compositions and methods of the present invention can comprise, consist of, or consist essentially of the essential elements and limitations of the invention described herein, as well as any additional or optional ingredients, components, or limitations described herein or otherwise useful. For example, the aqueous phase solvent system can “consist essentially of” water and C2-C5 monoalcohol, and/or the film forming system of the composition can consist essentially of the hydrophobically-modified polysaccharide compound and the aqueous phase film former; similarly, the oil phase film forming system can consist essentially of the hydrophobically-modified polysaccharide compound.

For purposes of the present invention, the “basic and novel property” associated with compositions, components and methods which “consist essentially of” identified ingredients or actions is transfer resistance.

Referred to herein are trade names for materials including, but not limited to polymers and optional components. The inventors herein do not intend to be limited by materials described and referenced by a certain trade name. Equivalent materials (e.g., those obtained from a different source under a different name or catalog (reference) number) to those referenced by trade name may be substituted and utilized in the methods described and claimed herein.

All percentages and ratios are calculated by weight unless otherwise indicated. All percentages are calculated based on the total weight of a composition unless otherwise indicated. All component or composition levels are in reference to the active level of that component or composition, and are exclusive of impurities, for example, residual solvents or by-products, which may be present in commercially available sources.

All U.S. patents or patent applications disclosed herein are expressly incorporated by reference in their entirety.

### Aqueous Phase Film Former

According to the present invention, compositions including one or more aqueous phase film-forming polymers (“first film-forming polymers” or “first film formers”) that is/are non-ionic water-soluble or water dispersible polymer are provided. For clarity, by “non-ionic water-soluble or water-dispersible” it is meant that the polymer is non-ionic. The polymer is also water-soluble or water-dispersible, particularly to the extent that it can be readily stabilized throughout a vehicle (e.g., water) present in the composition.

The one or more of these first film-forming polymers are part of an aqueous phase film-forming system. The aqueous phase film forming system can comprise, consist essentially of, or consist of one aqueous phase film former.

Examples of aqueous phase film forming polymer include, but are not limited to, homopolymers and copolymers containing at least one (meth)acrylic acid ((meth)acrylate) monomer and/or at least one vinyl (e.g. vinylpyrrolidone) monomer such as polyvinylpyrrolidone, polyvinyl alcohol, vinyl pyrrolidone/vinyl acetate copolymers, vinyl pyrrolidone/acrylic acid copolymers, vinyl pyrrolidone/acrylate copolymers, alkyl (e.g., butyl) acrylate/hydroxyalkyl (e.g., propyl) dimethicone acrylate copolymers, styrene/acrylates/ammonium methacrylate copolymers, acrylamide/sodium acryloyldimethyltaurate copolymer, etc.; water-soluble polysaccharides such as pectin, unmodified pullulan or cellulose compounds; polyurethanes; latexes; and mixtures thereof. According to certain embodiments, the aqueous phase film forming polymer is selected from a group consisting of polyvinylpyrrolidone, vinylpyrrolidone/vinyl acetate copolymer, vinylpyrrolidone/acrylic acid copolymer, polyvinyl alcohol, copolymer of N-vinyl pyrrolidone, methacrylamide, and N-vinylimidazole. According to certain other embodiments, the aqueous phase film forming polymer is a copolymer comprising a vinyl pyrrolidone monomer (and one or more second monomers). The one or more second monomers may include, for example cyclic amides, cyclic amines, (meth)acrylate, (meth)acrylamide, or other monomers different from vinylpyrrolidone.

According to preferred embodiments, the at least one aqueous phase film forming polymer is at least one cyclic amide-containing polymer. Preferably, the at least one cyclic amide-containing polymer also has at least one of cyclic amine and/or acrylamide functionality as well, preferably both of these, although it is possible for the at least one polymer to contain neither cyclic amine nor acrylamide functionality.

Cyclic amide and cyclic amine monomers useful in the preferred first film-forming polymers include those having one or more aromatic or aliphatic ring structures. These rings may have sizes ranging from about having sizes of, for example, 5 to 8 ring members.

In certain embodiments, monomers useful in forming these first film-forming polymers are polymerizable, ethylenically-unsaturated monomers having a cyclic amine residue or a cyclic amide residue. Accordingly, the cyclic amide monomers of these first film-forming polymers may include cyclic amide residues that are or include heterocyclic ring structures such as lactams and the like. These may include α-Lactam, β-lactam, γ-lactam, õ-lactam, and s-lactam. In one preferred embodiment, the cyclic amide is a pyrrolidone (a γ-lactam), in particular vinylpyrrolidone

Useful cyclic amine residues may include any of various heterocyclic amines such as azoles, pyrroles, pyrrolidines, carbamates, and the like. In one preferred embodiment, the cyclic amine residue is an imidazole.

In certain embodiments, acrylamide monomers useful in these first film-forming polymers include those having —C3H5NO functional groups. Examples include (meth)acrylamides.

As noted above, at least one cyclic amide-containing polymer preferably has at least one of cyclic amine and acrylamide functionality as well, preferably both, although it is possible that the polymer contains neither functionality. For example, polymer(s) containing cyclic amide residue(s) but not cyclic amine or acrylamide functionality include but are not limited to vinylpyrrolidone homopolymers (polyvinylpyrrolidone) and vinylpyrrolidone copolymers containing at least one monomer other than vinylpyrrolidone such as, for example, substituted or unsubstituted C2 (acrylic acid) or C3 (allyl) groups, possibly in the form of esters (for example, acrylates or methacrylates) or ethers.

In certain embodiments, the at least one aqueous phase film forming polymer has a weight average molecular weight in a range from about 10,000 daltons to about 1,000,000 daltons, including all ranges and subranges therebetween such as, for example, 50,000 daltons to 500,000 daltons, 75,000 daltons to 300,000 daltons, and 100,000 daltons to 250,000 daltons.

In certain embodiments, the at least one cyclic amide-containing polymer is a copolymer of N-vinyl pyrrolidone, methacrylamide, and N-vinylimidazole.

In certain embodiments, the at least one cyclic amide-containing polymer may be a commercially available variety, such as LUVISET CLEAR AT3, commercially available from BASF of Ludwigshafen, Germany.

According to preferred embodiments, the compositions of the present invention are devoid of, free of, or substantially free of, polyurethanes.

Preferably, the at least one aqueous phase film forming polymer is present in the compositions of the present invention in an amount ranging from about 0.5% to about 25% by weight, preferably from about 0.75% to about 20% by weight, preferably from 1% to about 10%, and preferably from about 1% to about 5% by weight with respect to the weight of the composition, including all ranges and subranges therebetween such as, for example, 4% to 15%, 1% to 3%, 3% to 25%, etc. Preferably, the at least one aqueous phase film forming polymer is present in the compositions of the present invention in an amount greater than 1% by weight of the total weight of the composition.

### Silicone Acrylate Copolymer

According to the present invention, compositions including at least one silicone acrylate copolymer are provided. Silicone acrylate copolymers are polymers containing siloxane group(s) and hydrocarbon group(s). For example, suitable polymers include polymers comprising a hydrocarbon backbone such as, for example, a backbone chosen from vinyl polymers, methacrylic polymers, and/or acrylic polymers and at least one chain chosen from pendant siloxane groups, and polymers comprising a backbone of siloxane groups and at least one pendant hydrocarbon chain such as, for example, pendant vinyl, methacrylic and/or acrylic group(s). Suitable silicone acrylate copolymers can comprise at least about 10%, 20%, 30%, 40%, 50%, 60%, 70%, 80%, or 90% silicone (siloxane groups) by weight, and can comprise at least about 10%, 20%, 30%, 40%, 50%, 60%, 70%, 80%, or 90% acrylate (hydrocarbon groups) by weight.

The at least one silicone acrylate copolymer can be chosen from silicone/(meth)acrylate copolymers, such as those as described in U.S. Pat. Nos. 5,061,481, 5,219,560, and 5,262,087, and U.S. patent application 2012/0301415, the entire contents of all of which are hereby incorporated by reference.

The at least one silicone acrylate copolymer may be selected from polymers derived from non-polar silicone copolymers comprising repeating units of at least one polar (meth)acrylate unit and vinyl copolymers grafted with at least one non-polar silicone chain. Non-limiting examples of non-dendrimer copolymers are acrylates/dimethicone copolymers such as those commercially available from Shin-Etsu, for example, the products sold under the tradenames KP-545 (cyclopentasiloxane (and) acrylates/dimethicone copolymer), KP-543 (butyl acetate (and) acrylates/dimethicone copolymer), KP-549 (methyl trimethicone (and) acrylates/dimethicone copolymer), KP-550 (INCI name: isododecane (and) acrylate/dimethicone copolymer), KP-561 (acrylates/stearyl acrylate/dimethicone acrylates copolymer), KP-562 (acrylates/behenyl acrylate/dimethicone acrylates copolymer), and mixtures thereof. Additional examples include the acrylate/dimethicone dendrimer copolymers sold by Dow Corning under the tradenames FA 4001 CM SILICONE ACRYLATE (cyclopentasiloxane (and) acrylates/polytrimethylsiloxymethacrylate copolymer) and FA 4002 ID SILICONE ACRYLATE (isododecane (and) acrylates/polytrimethylsiloxymethacrylate Copolymer), and mixtures thereof.

Further non-limiting examples of such polymers and their synthesis are disclosed, for example, in U.S. Pat. Nos. 4,972,037, 5,061,481, 5,209,924, 5,849,275, and 6,033,650, and PCT applications WO 93/23446, WO 95/06078 and WO 01/32737, the disclosures of all of which are hereby incorporated by reference. These polymers may be sourced from various companies. One such company is Minnesota Mining and Manufacturing Company which offers these types of polymers under the tradenames “Silicone Plus” polymers (for example, poly(isobutyl methacrylate-co-methyl FOSEA)-g-poly(dimethylsiloxane), sold under the tradename SA 70-5 IBMMF).

Other non-limiting examples of useful silicone acrylate copolymers include silicone/acrylate graft terpolymers, for example, the copolymers described in PCT application WO 01/32727, the disclosure of which is hereby incorporated by reference.

Other useful polymers can include those described in U.S. Pat. No. 5,468,477, the disclosure of which is hereby incorporated by reference. A non-limiting example of these polymers is poly(dimethylsiloxane)-g-poly(isobutyl methacrylate), which is commercially available from 3M Company under the tradename VS 70 IBM.

The silicone acrylate copolymer, if included, is preferably present in the compositions of the present invention in an active amount ranging from about 1% to about 25% such as 1%, 1.2%, 1.4% or 1.5%, 1.6%, 1.8% or 2% to about 2%, 4%, 5% 10%, 15%, 20% or 25%, all weights being based on the weight of the composition as a whole.

### Glycerolated Silicone Resin

In accordance with the present invention, compositions comprising at least one glycerolated silicone resin are provided.

Preferably, compositions of the present invention comprise a film forming component comprising at least one glycerolated silicone resin, at least two glycerolated silicone resins, at least three glycerolated silicone resins, at least four glycerolated silicone resins, etc. Accordingly, film forming components of the present invention can contain, for example, any number of glycerolated silicone resins such as from 1 to 10 such resins, 1-5 such resins, 1-3 such resins, etc.

The term “glycerolated silicone resin” is understood to mean a resin which comprises, in its chemical structure, one or more monoglycerol or polyglycerol group(s).

According to preferred embodiments of the invention, the glycerolated silicone resin(s) is (are) preferably present in a content as active material ranging from 0.1% to 40% by weight, with respect to the total weight of the composition, preferably ranging from 1% to 30% by weight and more preferably from 5% to 15% by weight, with respect to the total weight of the composition, including all ranges and subranges therebetween such as 1% to 5%, 5% to 25%, 12.5% to 30%, 2% to 12.5%, etc.

The glycerolated silicone resin(s) according to the invention are preferably chosen from those of following formula (1):

(R¹₃SiO_{1/2})ₐ(R²(CH₃)₂SiO_{1/2})_{b}(R³₃SiO_{1/2})_{c}(R¹₂SiO_{2/2})ₑ(SiO_{4/2})_{f} (1)
in which
   each R¹, which are identical or different, is an alkyl, aryl or aralkyl group of 1 to 30 carbon atoms, or a group substituted by a halogen, a group substituted by an amino or a group substituted by a carboxyl of the latter;
   each R² is a mono- or polyglycerol group of following general formula (2)

—(CH₂)₂—Cₗ H₂ₗ—O—(CH₂CH(OH)CH₂O)ₗR⁴ (2)
in which
   R⁴ is a substituted or unsubstituted monovalent hydrocarbon group or a hydrogen atom, and
   the indices l and i are numbers which satisfy the conditions 0≤l≤15 and 0<i≤5,
   each R³ is an identical or different group of general formula (3), of general formula (4), of general formula (5) or of general formula (6) below

### [Chem 3]

—(CH₂)₂—CₘH₂ₘ—(SiOR¹₂)ⱼⁱ—SiR¹₃ (3)

[Chem 4]

—(CH₂)₂—CₘH₂ₘ—SiR¹ₖ₁—(OSiR¹₃)₃₋ₖ₁₎ (4)

[Chem 5]

—(CH₂)₂—CₘH₂ₘ—SiR¹ₖ₁—(OSiR¹ₖ₂(OSiR¹₃)₃₋ₖ₂)₃₋ₖ₁ (5)

[Chem 6]

—(CH₂)₂—CₘH₂ₘ—SiR¹ₖ₁—(OSiR¹ₖ₂(OSiR¹ₖ₃(OSiR¹₃)₃₋ₖ₃)₃₋ₖ₂)₃₋ₖ₁ (6)
Where
   each R¹, which are identical or different, is an alkyl, aryl or aralkyl group of 1 to 30 carbon atoms, or a group substituted by a halogen, a group substituted by an amino or a group substituted by a carboxyl of the latter;
   the indices m, j and k₁ to k₃ are numbers which satisfy the conditions

$$0 \leq m \leq 5 , 0 \leq j \leq 500 , 0 \leq k 1 \leq 2 , 0 \leq {k}_{2} \leq 2 and 0 \leq {k}_{3} \leq 2 ;$$

the indices a, b, c, d, e and f are numbers which satisfy the conditions 0≤a≤400, 0<b≤200, 0≤c≤400, 0≤d≤320, 0≤e≤320, 0<f≤1000 and 0.5≤(a+b+c)/f≤1.5.

The glycerolated silicone resins according to the invention are described in the patent application US20200332065A1 of SHIN-ETSU.

According to a specific embodiment, the glycerolated silicone resin(s) of formula (1) as defined above are chosen from those for which
the indices b and c satisfy the conditions 0<b≤30 and 0≤c≤30;
the index i in the general formula (2) of the monoglycerol or polyglycerol group R² is a number which satisfies the condition 0<i≤3.

According to a specific embodiment, the glycerolated silicone resin(s) of formula (1) are in the solid form at 25° C. when the index c satisfies the condition 0<c≤400 and R³ is a group of general formula (3) where the index j satisfies the condition 0≤j≤10.

According to a specific embodiment, the glycerolated silicone resin(s) exhibit a weight-average molecular weight ranging from 1000 to 100 000.

The glycerolated silicone resin(s) according to the invention are amphiphilic, that is to say exhibit two parts of different polarities. In general, one is lipophilic (soluble or dispersible in an oily phase). The other is hydrophilic (soluble or dispersible in water). They are characterized by the value of their HLB (Hydrophilic-Lipophilic Balance), the HLB being the ratio of the hydrophilic part to the lipophilic part in the molecule. The term HLB is well known to a person skilled in the art and is described, for example, in “The HLB System. A Time-Saving Guide to Emulsifier Selection” published by ICI Americas Inc., 1984). The value of the HLB of the glycerolated silicone resins according to the invention preferably varies from 0.1 to 15 according to the Griffin method.

The glycerolated silicone resin(s) according to the invention can be obtained by a preparation process comprising the stage of hydrosilylation
A) of a silicone resin containing a hydrosilyl group of formula (7) below

(R¹₃SiO_{1/2})ₐ(HₙR¹₃₋ₙSiO_{1/2})_{b+c}(R¹₂SiO_{2/2})_{d}(R¹SiO_{3/2})ₑ(SiO_{4/2})_{f} (7)
in which:
   each R¹, which are identical or different, is an alkyl, aryl or aralkyl group of 1 to 30 carbon atoms, or a group substituted by a halogen, a group substituted by an amino or a group substituted by a carboxyl of the latter;
   the indices a, b, c, d, e and f are numbers which satisfy the conditions 0≤a≤400, 0<b≤200, 0≤c≤400, 0≤d≤320, 0≤e≤320, 0<f≤1000 and 0.5≤(a+b+c)/f≤1.5;
   n is a number which satisfies a condition 1≤n≤3, with
B) one or more compounds which are chosen from the compounds terminated by an alkenyl group of general formulae (8), (9), (10), (11) and (12) below]

CH₂═CH—CₗH₂ₗ—O—(CH₂CH(OH)CH₂O)iR⁴ (8)

[Chem 9]

CH₂=CH—CₘH₂ₘ—(SiOR¹₂)ⱼ—SiR¹₃ (9)

[Chem 10]

CH₂═CH—CₘH₂ₘ—SiR¹ₖ₁—(OSiR¹₃)₃₋ₖ₁ (10)

[Chem 11]

CH₂═CH—CₘH₂ₘ—SiR¹ₖ₁—(OSiR¹ₖ₂(OSiR¹3)₃₋ₖ₂)₃₋ₖ₂)₃₋ₖ₁ (11)

[Chem 12]

CH═CH—CH₂—CₘH₂ₘ—SiR¹k¹-(OSiR¹k^{k2}(OSiR¹ₖ₃(OSiR¹₃)₃₋ₖ₃)₃₋ₖ₂₎₃₋ₖ₁ (12)
Where
   R⁴ is a substituted or unsubstituted monovalent hydrocarbon group or a hydrogen atom,
   the indices l and i are numbers which satisfy the conditions 0≤l≤15 and 0<i≤5;
   the indices m, j and k₁ to k₃ are numbers which satisfy the conditions 0≤m≤5, 0≤j≤500, 0≤k₁≤2, 0≤k₂≤2 and 0≤k₃≤2; said silicone resin containing a hydrosilyl group of formula (7) which reacts with at least one compound in the formula (8).

The hydrosilylation reaction is carried out in the presence, for example, of a platinum or rhodium catalyst. The preferred ranges for b, c, d, e, f, R⁴, l, m, i, j and k₁ to k₃ are as defined above.

### Process for the Preparation of the Glycerolated Silicone Resin

A specific example of process for the preparation of the glycerolated silicone resin according to the invention is described below.

As mentioned above, the glycerolated silicone resin according to the invention can be obtained by the stage of hydrosilylation
(A) of a silicone resin containing a hydrosilyl group of mean formula (7) below:

(R¹₃SiO_{1/2})ₐ(HₙR¹₃₋ₙSiO_{1/2})_{b+c}(R¹₂SiO_{2/2})_{d}(R¹SiO_{3/2})ₑ(SiO_{4/2})_{f} (7)
in which
   each R¹ is an identical or different alkyl, aryl or aralkyl group of 1 to 30 carbon atoms, or a group substituted by a halogen, a group substituted by an amino or a group substituted by a carboxyl of the latter;
   the indices a, b, c, d, e and f are numbers which satisfy the conditions 0≤a≤400, 0<b≤200, 0≤c≤400, 0≤d≤320, 0≤e≤320, 0<f≤1000 and 0.5≤(a+b+c)/f≤1.5;
   n is a number which satisfies the condition 1≤n≤3, with
(B) one or more compounds which are chosen from the compounds terminated by an alkenyl group of general formulae (8), (9), (10), (11) and (12) below

CH₂═CH—CₗH₂ₗ—O—(CH₂CH(OH)CH₂O)iR⁴ (8)

CH₂═CH—CₘH₂ₘ—(SiOR¹₂)ⱼ—SiR¹₃ (9)

CH₂═CH—CₘH₂ₘ—SiR¹ₖ₁—(OSiR¹₃)₃₋ₖ₁ (10)

CH₂═CH—CₘH₂ₘ—SiR¹ₖ₁—(OSiR¹ₖ₂(OSiR¹₃)₃₋ₖ₃)₃₋ₖ₂₎₃₋ₖ₁ (11)

CH═CH—CH₂—CₘH₂ₘ—SiR¹ₖ₁—(OSiR¹ₖ₂—(OSiR¹ₖ₃(OSiR¹₃)₃₋ₖ₃)₃₋ₖ₂)₃₋ₖ₁ (12)
Where
   R⁴ is a substituted or unsubstituted monovalent hydrocarbon group or a hydrogen atom,
   the indices l and i are numbers which satisfy the conditions 0≤l≤15 and 0<i≤5;
   the indices m, j and k₁ to k₃ are numbers which satisfy the conditions 0≤m≤5, 0≤j≤500, 0≤k₁≤2, 0≤k₂≤2 and 0≤k₃≤2; said comprise a compound of general formula (8).

The organosilicon resin containing hydrosilyl groups of mean composition formula (7) and the compound having terminal alkenyl groups of general formula (8), (9), (10), (11) or (12) are mixed in a molar ratio, expressed as hydrosilyl groups/terminal unsaturated groups, which is preferably from 0.5 to 2.0 and more preferentially from 0.8 to 1.2.

The addition reaction is preferably carried out in the presence of a platinum or rhodium catalyst. Specific examples include chloroplatinic acid, chloroplatinic acid modified by an alcohol and chloroplatinic acid/vinylsiloxane complexes. When an excessive amount of catalyst is included, a discoloration of the sample is produced, and thus the amount of platinum or of rhodium is preferably 50 ppm or less and more preferably 20 ppm or less.

In addition, if necessary, the addition reaction can be carried out in the presence of an organic solvent. Mention may be made, among the examples of organic solvent, of cyclic organopolysiloxanes, such as octamethylcyclotetrasiloxane, decamethylcyclopentasiloxane and dodecamethylcyclohexasiloxane; aromatic hydrocarbons, such as toluene and xylene; solvents of ketone type, such as acetone, methyl ethyl ketone, diethyl ketone and methyl isobutyl ketone; aliphatic hydrocarbons, such as hexane, heptane, octane and cyclohexane; and aliphatic alcohols, such as methanol, ethanol, 1-propanel, 2-propanol, 1-butanol, 2-methyl-1-propanol, 2-butanol, 2-methyl-2-propanol, 1-pentanol, 2-methylbutanol, 2-pentanol, 1-hexanol, 2-methylpentanol, 1-heptanol, 1-octanol, 1-nonanol, 1-decanol, phenol, benzyl alcohol, ethylene glycol and 1,2-propylene glycol. From the viewpoint of the reactivity, ethanol, 1-propanol and 2-propanol are preferred.

The amount of solvent used is preferably from 1% to 80% and more preferably from 5% to 50% of the overall reaction system. In the above range, the reaction system is kept uniform and the reaction takes place efficiently.

The conditions of the addition reaction are not particularly limited, although heating at reflux at a temperature of between 5° and 150° C., in particular between 8° and 120° C., for approximately 1 to 10 hours is preferred.

After the addition reaction, the stage of removal of the rhodium or platinum catalyst used with activated carbon can be included. The amount of activated carbon used is preferably from 0.001% to 5.0% and in particular from 0.01% to 1.0% of the overall system. The discoloration of the sample can be better suppressed by fixing the amount of activated carbon in this range.

After the addition reaction, if necessary, the stage of removal of the remaining hydrosilyl groups can be included. In particular in the cases where use in applications such as cosmetic preparations is anticipated, there exists a possibility of these hydrosilyl groups becoming deactivated over time due to dehydrogenation reactions, which presents a problem from the viewpoint of safety. It is thus preferable to include a stage of maintenance of the hydrosilyl groups.

An example of stage of removal of the hydrosilyl groups is the process of hydrolysis of the unreacted hydrosilyl groups by the addition of a basic catalyst, such as an alkali metal carbonate, an alkali metal bicarbonate or an alkali metal hydroxide, and then neutralization by the addition of an amount of acid catalyst equal to the molar equivalent of the basic catalyst. Specific examples of the basic catalyst comprise strong basic catalysts, such as lithium hydroxide, sodium hydroxide, potassium hydroxide, calcium hydroxide and barium hydroxide; and weak basic catalysts, such as sodium carbonate, calcium carbonate and sodium bicarbonate. From the viewpoint of the promotion of the dehydrogenation reaction, the use of a strong basic catalyst is particularly preferred, sodium hydroxide being particularly preferred. Mention may be made, among acid catalysts, of hydrochloric acid, sulfuric acid, sulfurous acid, fuming sulfuric acid, oxalic acid, p-toluenesulfonic acid, methanesulfonic acid, trifluoroacetic acid, trifluoromethanesulfonic acid, phosphoric acid, formic acid, acetic acid, propionic acid, benzoic acid and citric acid. In general, instead of using the acid alone or the base alone, it is preferable to use them with water and to heat them to a temperature which is not greater than the boiling point of water.

After the addition reaction, if necessary, the stage of deodorization to reduce the odor can be included. When use in applications such as cosmetic preparations in particular is anticipated, because the product acquires an odor with time, it is preferable to include a stage of deodorization. The mechanism for the deodorization of ordinary silicones modified by polyethers can be explained as follows. When an addition reaction between a polyether etherified by allyl groups and a hydropolyorganosiloxane is carried out in the presence of a platinum catalyst, the allyl groups rearrange internally in the form of side reactions, forming a polyether etherified by propenyl groups. This propenyl-etherified polyether has no reactivity with the polyorganosiloxane hydrogen and thus remains in the system as an impurity. It is believed that when water acts on this propenyl-etherified polyether, the propenyl ether hydrolyzes, giving rise to propionaldehyde, which gives off an unpleasant odor. It is known that the above hydrolysis reaction is also promoted in the presence of an acid catalyst. Consequently, when the silicone modified by a polyether is used in a water-based cosmetic preparation, due to the oxidative deterioration of the polyether, the preparation tends to become acidic with time, promoting the hydrolysis reaction described above and bringing about the appearance of a bad odor.

Typical examples of the stage of deodorization comprise two approaches. The first is that in which, by adding an acid catalyst to the solution after the addition reaction, any propenyl ether remaining in the system is hydrolyzed and the propionaldehyde which is formed is removed by strip purification (JP No. 2137062).

Specific examples of the acid catalyst used in the first approach comprise hydrochloric acid, sulfuric acid, sulfurous acid, fuming sulfuric acid, oxalic acid, p-toluenesulfonic acid, methanesulfonic acid, trifluoroacetic acid, trifluoromethanesulfonic acid, phosphoric acid, formic acid, acetic acid, propionic acid, benzoic acid and citric acid. These acids are used in combination with water. In the case where it is necessary to remove the acid which has been used, it is preferable to use an acid having a low boiling point, such as hydrochloric acid, formic acid, acetic acid or trifluoroacetic acid. Likewise, from the viewpoint of the effectiveness of the treatment, it is preferable to use a strong acid, such as hydrochloric acid or trifluoroacetic acid.

The treatment temperature is preferably fixed at 80° C. or less in order to prevent the oxidation of the hydrophilic groups. The amount of acidic aqueous solution added is preferably fixed from 0.1% to 100%, with respect to the organosilicon resin modified by organic groups. The use of 5% to 30% is more preferred.

From the viewpoint of the productivity, the process consisting of adding an aqueous solution to the post reaction solution so as to regulate the pH at 7 or less and of carrying out a strip purification after stirring under heating is preferred. The purification of the strip can be carried out at normal temperature or under reduced pressure. The temperature conditions are preferably fixed at 120° C. or less. In order to efficiently purify the strip under these temperature conditions, it is preferable to carry out this operation under reduced pressure; when it is carried out at normal pressure, the operation is preferably carried out under a stream of inert gas, such as nitrogen or argon.

The second approach is that in which, by adding hydrogen to the solution after the addition reaction, the unsaturated double bonds are alkylated (subjected to a hydrogenation reaction) and the formation of propionaldehyde over time is controlled in a stable manner (U.S. Pat. No. 5,225,509; JP-A H07-330907).

The hydrogenation reactions comprise methods involving the use of hydrogen and methods involving the use of metal hydrides, and there also exist homogeneous reactions and heterogeneous reactions. These methods can be used alone but it is also possible to use in them combination. However, given the advantage that there is no trace of catalyst used in the product, a heterogeneous catalytic hydrogenation reaction using a solid catalyst is preferred.

The solid catalyst is, for example, nickel, palladium, platinum, rhodium, cobalt, chromium, copper, iron and others, in the uncombined form or in the compound form. In this case, it is not necessary to use a catalyst support. However, when a catalyst support is used, the support can, for example, be activated carbon, silica, silica/aluminum, aluminum or zeolite. These catalysts can be used alone but it is also possible to use them in combination. The preferred catalyst is Raney nickel, which is economically advantageous. As the Raney nickel is generally developed and used with an alkali, it is necessary to carefully measure the pH of the reaction system. Furthermore, the reaction system becomes weakly alkaline, which is particularly effective for the deodorization when the hydrolysis reaction is carried out with an acidic aqueous solution.

It is preferable to carry out the hydrogenation reaction at a pressure generally of between 1 and 100 MPa and between 5° and 200° C. The hydrogenation reaction can be carried out batchwise or continuously. When it is a noncontinuous process, the reaction time depends, for example, on the amount of catalyst and on the temperature but it is generally of between 3 and 12 hours. The hydrogen pressure can be adjusted to an appropriate fixed pressure. The final point of the hydrogenation reaction is the point at which the hydrogen pressure has ceased to change and it can thus be determined by carefully monitoring a manometer.

The amount of aldehyde included in the glycerolated silicone resin which has been purified by this acid treatment and this hydrogenation treatment can be fixed at 70 ppm or less, preferably at 20 ppm or less and more preferably at 10 ppm or less.

It is also possible to combine both types of abovementioned deodorization stages. In the approach which involves an acid treatment, the decomposition and the removal of the aldehyde compound is possible but, as there is a limit to the complete removal of the unsaturated double bonds, the formation of odorous aldehyde from that cannot be completely suppressed. In the approach which involves a hydrogenation reaction, by eliminating the unsaturated double bonds, it is possible to reduce the amount of aldehyde compound which is formed because of that. However, the aldehyde condensate which is formed with the condensation of a portion of the aldehyde remains in the system even after such a treatment has been carried out and the removal by strip purification is also difficult. Consequently, by alkylating the unsaturated double bonds which remain when the solution, following the addition reaction, is subjected to hydrogenation, and by subsequently decomposing the aldehyde condensate in the system by adding an acid catalyst, complete deodorization is possible (WO2002/05588).

The weight-average molecular weight of the glycerolated silicone resin of mean formula (1) preferably varies from 1000 to 100 000; from the viewpoint of the performance qualities and of the ease of the operations, such as the filtration, the weight-average molecular weight preferentially varies from 3000 to 50 000. Here and subsequently, the weight-average molecular weight can be determined as the polystyrene-equivalent weight-average molecular weight in gel permeation chromatography (GPC).

The glycerolated silicone resin according to the invention is in a form at 25° C. which can be solid or liquid; from the viewpoint of the formability of the film, it is preferably solid.

In particular, the glycerolated silicone resin according to the invention of formula (1) for which the indices b and c satisfy the conditions 0<b≤30 and 0≤c≤30, the index i in the general formula (2) is a number which satisfies the condition 0<i≤3 and the index j in the general formula (3) satisfies the condition 0≤j≤10 is the form of a solid at 25° C. and preferably exhibits a weight-average molecular weight which preferably varies from 1000 to 100 000 and more preferentially from 3000 to 50 000.

The glycerolated silicone resins according to the invention have a hydrophilic-lipophilic balance (HLB), as determined by the Griffin formula, preferably of 0.1 to 15 and more preferably of 1.0 to 8.0.

According to a preferred form, the composition of the invention comprises at least one glycerolated silicone resin in the formula (1) of the (3-Glyceroxypropyl) Dimethylsiloxy Trimethylsiloxysilicate type corresponding to the following formula (21):

[(CH₃)₃SiO_{1/2}]ₐ[R(CH₃)₂SiO_{1/2}]_{b}(SiO_{4/2})_{f} (21)
Where
   R denotes the 3-glyceroxypropyl group of structure
   C₃H₆OCH₂—CH(OH)CH₂OH;
   the indices a, b and f are numbers which satisfy the conditions 0≤a≤400, 0<b≤30, 0<f≤1000 and 0.5≤(a+b)/f≤1.5.

According to a particularly preferred form, the glycerolated silicone resin of the (3-Glyceroxypropyl) Dimethylsiloxyl Trimethylsiloxysilicate type of formula (21) is in the form of a solution in at least one volatile oil.

The term “volatile oil” is understood to mean, within the meaning of the invention, any oil capable of evaporating on contact with the skin in less than one hour, at ambient temperature and atmospheric pressure. The volatile oil is a volatile cosmetic compound, liquid at ambient temperature, having in particular a non-zero vapor pressure, at ambient temperature and atmospheric pressure, in particular having a vapor pressure ranging from 2.66 Pa to 40 000 Pa, in particular ranging from 2.66 Pa to 13 000 Pa and more particularly ranging from 2.66 Pa to 1300 Pa.

The volatile oil in accordance with the invention can be chosen from the group constituted of hydrocarbon oils, silicone oils and their mixtures.

The term “hydrocarbon oil” is understood to mean an oil containing predominantly hydrogen and carbon atoms and optionally one or more functions chosen from hydroxyl, ester, ether and carboxyl functions.

Within the meaning of the present invention, the term “silicone oil” denotes an oil comprising at least one Si—O group and more particularly an organopolysiloxane.

The volatile hydrocarbon oils which can be used in the compositions according to the invention can be chosen from branched C8-C16 alkanes.

Mention may in particular be made, as C8-C16 isoalkanes of petroleum origin (also known as isoparaffins), such as isododecane (also known as 2,2,4,4,6-pentamethylheptane or “IDD”), isodecane, isohexadecane and, for example, the oils sold under the Isopar® or Permethyl® tradenames. More preferentially, isododecane will be used.

Mention may be made, by way of example of volatile silicone oil which can be used in the invention, of volatile silicone oils, such as volatile linear or cyclic silicone oils, in particular those having a viscosity of 2 to 8 centistokes (2.10-6 to 8.10-6 m2/s) and containing in particular from 2 to 7 silicon atoms, these silicones optionally comprising alkyl or alkoxy groups containing from 1 to 10 carbon atoms. Mention may in particular be made, as volatile silicone oils which can be used in the invention, of octamethylcyclotetrasiloxane, decamethylcyclopentasiloxane, dodecamethylcyclohexasiloxane, heptamethylhexyltrisiloxane, heptamethyloctyltrisiloxane, hexamethyldisiloxane, octamethyltrisiloxane, decamethyltetrasiloxane and dodecamethylpentasiloxane; and their mixtures. More preferentially, decamethylcyclopentasiloxane (D₅) will be used.

According to a particularly preferred form, the glycerolated silicone resin of the (3-Glyceroxypropyl) Dimethylsiloxy Trimethylsiloxysilicate type of formula (21) is in the form of the solution comprising 49.5% by weight of active material in isododecane, such as the product manufactured under the tradename X-25-9138A® by SHIN ETSU with a weight-average molecular weight of 11 000.

The glycerolated silicone resin, if included, is preferably present in the compositions of the present invention in an active amount ranging from about 1% to about 25% such as 1%, 1.2%, 1.4% or 1.5%, 1.6%, 1.8% or 2% to about 2%, 4%, 5% 10%, 15%, 20% or 25%, all weights on an actives basis and being based on the weight of the composition as a whole.

For embodiments in which both a silicone acrylate copolymer and a glycerolated silicone resin are included, the total amount of these materials, on an actives basis may also range from about 1% to about 25% such as 1%, 1.2%, 1.4% or 1.5%, 1.6%, 1.8% or 2% to about 2%, 4%, 5% 10%, 15%, 20% or 25%, all weights being based on the weight of the composition as a whole.

Preferably, the weight ratio of active material of (1) the sum of silicone acrylate copolymer and glycerolated silicone resin to (2) aqueous phase film former (e.g., copolymer of N-vinyl pyrrolidone, methacrylamide, and N-vinylimidazole) is from about 0.5:1, 1:1: or 1 5:1 to about 1.75:1, 2:1, 3:1 or 5:1.

### Aqueous Phase

According to preferred embodiments of the present invention, compositions comprising an aqueous phase solvent system comprising (i) water in an amount of at least about 10% by weight with respect to the total weight of the composition; and (ii) optionally, at least one C2-C5 monoalcohol are provided. Preferably, the composition is in the form of an emulsion with a continuous outer phase which is aqueous, preferably an oil-in-water (o/w) emulsion.

According to preferred embodiments, the compositions of the present invention comprise water. Preferably, the compositions comprise at least about 10% water by weight, preferably greater than 20% water by weight, preferably greater than about 25% water by weight, and preferably greater than about 30% water by weight, preferably in amounts ranging from about 30%, 40%, or 50% to about 50%, 60%, 70%, 80%, or 90%, all weights being based on the weight of the composition as a whole.

Suitable C2-C5 monoalcohols, if present, include ethanol, propanol, butanol, pentanol, isopropanol, isobutanol and isopentanol. Ethanol is particularly preferred.

Preferably, the C2-C5 monoalcohol(s), if present, is/are present in the compositions of the present invention in an amount ranging from about 1% to about 50%, preferably in amounts ranging from about 1%, 5%, or 10% or 15% to about 15%, 20%, 25%, 30%, or 50%, all weights being based on the weight of the composition as a whole.

Preferably, the aqueous phase solvent system of the compositions of the present invention consists essentially of, or consists of, water and, optionally, C2-C5 monoalcohols. Preferably, the aqueous phase solvent system is “free of,” “devoid of” or “substantially free of” solvents other than water and, optionally, C2-C5 monoalcohols.

### Oil Phase

According to the present invention, compositions comprising at least one oil are provided. Compositions of the present invention preferably comprise sufficient oil to form an oil-in-water emulsion, and having one or more oils preferably in an amount ranging from about 1%, 5%, or 10% or 15% to about 5%, 10%, 15%, 20%, 25%, 30%, or 50%, where all weights being based on the weight of the composition as a whole.

Suitable oils include volatile and/or non-volatile oils. Such oils can be any acceptable oil including but not limited to silicone oils and/or hydrocarbon oils.

According to certain embodiments, the oil carrier comprises one or more volatile silicone oils. Examples of such volatile silicone oils include linear or cyclic silicone oils having a viscosity at room temperature less than or equal to 6 cSt and having from 2 to 7 silicon atoms, these silicones being optionally substituted with alkyl or alkoxy groups of 1 to 10 carbon atoms. Specific oils that may be used in the invention include octamethyltetrasiloxane, decamethylcyclopentasiloxane, dodecamethylcyclohexasiloxane, heptamethyloctyltrisiloxane, hexamethyldisiloxane, decamethyltetrasiloxane, dodecamethylpentasiloxane and their mixtures. Other volatile oils which may be used include KF 96A of 6 cSt viscosity, a commercial product from Shin Etsu having a flash point of 94° C. Preferably, the volatile silicone oils have a flash point of at least 40° C.

Non-limiting examples of volatile silicone oils are listed in Table 1 below.

TABLE 1

| | Flash Point | Viscosity |
|---|---|---|
| Compound | (° C.) | (cSt) |
| Octyltrimethicone | 93 | 1.2 |
| Hexyltrimethicone | 79 | 1.2 |
| Decamethylcyclopentasiloxane | 72 | 4.2 |
| (cyclopentasiloxane or D5) | | |
| Octamethylcyclotetrasiloxane | 55 | 2.5 |
| (cyclotetradimethylsiloxane or D4) | | |
| Dodecamethylcyclohexasiloxane (D6) | 93 | 7 |
| Decamethyltetrasiloxane(L4) | 63 | 1.7 |
| KF-96 A from Shin Etsu | 94 | 6 |
| PDMS (polydimethylsiloxane) DC 200 | 56 | 1.5 |
| (1.5 cSt) from Dow Corning | | |
| PDMS DC 200 (2 cSt) from Dow Corning | 87 | 2 |

Further, a volatile linear silicone oil may be employed in the present invention. Suitable volatile linear silicone oils include those described in U.S. Pat. No. 6,338,839 and WO03/042221, the contents of which are incorporated herein by reference. In one embodiment the volatile linear silicone oil is decamethyltetrasiloxane. In another embodiment, the decamethyltetrasiloxane is further combined with another solvent that is more volatile than decamethyltetrasiloxane.

According to other embodiments, the oil carrier comprises one or more non-silicone volatile oils and may be selected from volatile hydrocarbon oils, volatile esters and volatile ethers. Examples of such volatile non-silicone oils include, but are not limited to, volatile hydrocarbon oils having from 8 to 16 carbon atoms and their mixtures and in particular branched Cs to C16 alkanes such as Cs to C16 isoalkanes (also known as isoparaffins), isododecane, isodecane, and for example, the oils sold under the trade names of Isopar or Permethyl. Preferably, the volatile non-silicone oils have a flash point of at least 40° C.

Non-limiting examples of volatile non-silicone volatile oils are given in Table 2 below.

TABLE 2

| Compound | Flash Point (° C.) |
|---|---|
| Isododecane | 43 |
| Propylene glycol n-butyl ether | 60 |
| Ethyl 3-ethoxypropionate | 58 |
| Propylene glycol methylether acetate | 46 |
| Isopar L (isoparaffin C₁₁-C₁₃) | 62 |
| Isopar H (isoparaffin C₁₁-C₁₂) | 56 |
| Undecane | 62 |
| Tridecane | 94 |
| Isohexadecane | 96 |

The volatility of the solvents/oils can be determined using the evaporation speed as set forth in U.S. Pat. No. 6,338,839, the contents of which are incorporated by reference herein.

According to other embodiments of the present invention, the oil carrier comprises at least one non-volatile oil. Examples of non-volatile oils that may be used in the present invention include, but are not limited to, polar oils such as:
hydrocarbon-based plant oils with a high triglyceride content consisting of fatty acid esters of glycerol, the fatty acids of which may have varied chain lengths, these chains possibly being linear or branched, and saturated or unsaturated; these oils are especially wheat germ oil, corn oil, sunflower oil, karite butter, castor oil, sweet almond oil, macadamia oil, apricot oil, soybean oil, rapeseed oil, cottonseed oil, alfalfa oil, poppy oil, pumpkin oil, sesame seed oil, marrow oil, avocado oil, hazelnut oil, grape seed oil, blackcurrant seed oil, evening primrose oil, millet oil, barley oil, quinoa oil, olive oil, rye oil, safflower oil, candlenut oil, passion flower oil or musk rose oil; or caprylic/capric acid triglycerides, for instance those sold by the company Stearineries Dubois or those sold under the names Miglyol 810, 812 and 818 by the company Dynamit Nobel;
synthetic oils or esters of formula R₅COOR₆ in which R₅ represents a linear or branched higher fatty acid residue containing from 1 to 40 carbon atoms, including from 7 to 19 carbon atoms, and R₆ represents a branched hydrocarbon-based chain containing from 1 to 40 carbon atoms, including from 3 to 20 carbon atoms, such as, for example, Purcellin oil (cetostearyl octanoate), isononyl isononanoate, C₁₂ to C₁₅ alkyl benzoate, isopropyl myristate, 2-ethylhexyl palmitate, and octanoates, decanoates or ricinoleates of alcohols or of polyalcohols; hydroxylated esters, for instance isostearyl lactate or diisostearyl malate; and pentaerythritol esters;
synthetic ethers containing from 10 to 40 carbon atoms;
C8 to C26 fatty alcohols, for instance oleyl alcohol, cetyl alcohol, stearyl alcohol, and cetearly alcohol; and
mixtures thereof.

Further, examples of non-volatile oils that may be used in the present invention include, but are not limited to, non-polar oils such as branched and unbranched hydrocarbons and hydrocarbon waxes including polyolefins, in particular Vaseline (petrolatum), paraffin oil, squalane, squalene, hydrogenated polyisobutene, hydrogenated polydecene, polybutene, mineral oil, pentahydrosqualene, and mixtures thereof.

According to preferred embodiments, the compositions of the present invention are devoid of, free of, or substantially free of, silicone oils.

According to preferred embodiments, the compositions of the present invention are devoid of, free of, or substantially free of, non-volatile oils.

According to preferred embodiments, the compositions of the present invention are devoid of, free of, or substantially free of, waxes.

### High HLB Surfactant

According to certain embodiments of the present invention, compositions may include at least one high HLB surfactant. “HLB” refers to the “hydrophilic-lipophilic balance” associated with emulsifiers/surfactants. In particular, “HLB” value relates to the ratio of hydrophilic groups and lipophilic groups in emulsifiers, and also relates to solubility of the emulsifiers. Lower HLB emulsifiers are more soluble in oils (lipophilic material) and are more appropriate for use in water-in-oil (W/O) emulsions. Higher HLB emulsifiers are more soluble in water (hydrophilic material) and are more appropriate for oil-in-water (O/W) emulsions. In the context of the present invention, “high HLB surfactant” means a surfactant having an HLB value of greater than 8. Also, in the context of the present invention, “high HLB value” means a surfactant having an HLB value greater than or equal to 8, preferably greater than or equal to 9, preferably greater than or equal to 10, preferably greater than or equal to 12, and preferably greater than or equal to 13.

Examples of surfactants include, but are not limited to, the following:
Polyethylene glycolated (PEG) and/or glycerolated esters or ethers, such as polyethylene glycolated and/or glycerolated branched or linear C8-C24 compounds, for example, Oleth-50, Oleth-20, Oleth-10, Ceteth-10, Steareth-20, Laureth-23, PEG-8 stearate, PEG-8 isostearate, PEG-20 stearate PEG-40 stearate, etc.;
sorbitan esters or ethers, such as oxyethylenated or nonoxyethylenated sorbitan mono- or polyalkyl esters or ethers, such as Polysorbate 21, Polysorbate 40, Polysorbate 80, Polysorbate 60, Polysorbate 61, sorbitan isostearate, glyceryl sorbitan isostearate, sorbitan sesquioleate, sorbitan laurate, sorbitan monopalmitate, sorbitan oleate, sorbitan trioleate, sorbitan monostearate and sorbitan tristearate, etc.;
Sugar mono- or polyalkyl esters or ethers, such as the mono- or polyalkyl esters or ethers of sugars as described in the patent U.S. Pat. No. 6,689,371. Mention may be made, for example, of methyl glucose isostearate, sucrose distearate, sucrose stearate, etc.;
Alkoxylated alkenyl succinates; and
Silicone derivatives, such as dimethicone copolyols, for example the mixture of cyclomethicone and of dimethicone copolyol sold under the name “DC 5225 C” by Dow Corning, and alkyl dimethicone copolyols, such as lauryl methicone copolyol, sold under the name “Dow Corning 5200 Formulation Aid” by Dow Corning, and cetyl dimethicone copolyol, sold under the name “Abil EM 90” by Goldschmidt, or the polyglyceryl-4 isostearate/cetyl dimethicone copolyol/hexyl laurate mixture sold under the name “Abil WE 90” by Goldschmidt.

The at least one high HLB surfactant is preferably present in the compositions of the present invention in an amount of about 0.1% to about 5%, preferably from about 0.1% to about 4%, and preferably from about 0.1% to about 3% by weight with respect to the total weight of the composition, including all ranges and subranges therebetween.

### Gelling Agent/Colorant/Active Agent

### Gelling Agent

According to preferred embodiments of the present invention, compositions further comprising at least one gelling agent are provided. Suitable gelling agents include any gelling agent, such as for example, gums, clays and acrylic acid (co) polymers, such as high molecular weight homo- or co-polymers comprising acrylic acid, optionally crosslinked with a polyalkenyl polyether, including some polymers identified as “carbomer” as well as amphiphilic polymers. Preferably, the gelling agent is a gum, an amphiphilic polymer or a clay, or a combination of any of these.

According to preferred embodiments, the at least one gelling agent is preferably at least one gum. Suitable examples of thickening gums include, but are not limited to, Suitable gums include xanthan, sclerotium, pectin, karaya, arabic, gelatin, agar, guar, carrageenan, alginate and combinations thereof.

According to preferred embodiments, the at least one gelling agent is preferably at least one amphiphilic polymer, comprising at least one ethylenically unsaturated monomer, preferably containing a sulphonic group, in freeform or partially or totally neutralized form.

The amphiphilic polymers may comprise at least one hydrophobic portion. The hydrophobic portion present in these polymers preferably contains from 6 to 50 carbon atoms, preferably from 6 to 22 carbon atoms, preferably from 6 to 18 carbon atoms and preferably from 12 to 18 carbon atoms, including all ranges and subranges therebetween.

The amphiphilic polymers may have a molar mass ranging from 50,000 g/mole to 10,000,000 g/mole, preferably from 80,000 g/mole to 8,000,000 g/mole, and preferably from 100,000 g/mole to 7,000,000 g/mole.

The amphiphilic polymers may be based on at least one ethylenically unsaturated hydrophilic monomer A and on at least one hydrophobic monomer B. Preferably, the monomer A comprises a strong acid function, in particular a sulphonic acid or phosphonic acid function. The hydrophobic monomer B comprises at least one hydrophobic radical, chosen from: saturated or unsaturated C₆-C₁₈ linear alkyl radicals (for example, n-hexyl, n-octyl, n-decyl, n-hexadecyl, n-dodecyl or oleyl); branched alkyl radicals (for example, isostearic) or cyclic alkyl radicals (for example, cyclododecane or adamantane); C₆-C₁₈ fluoro or alkylfluoro radicals (for example, the group of formula —(CH₂)₂—(CF₂)₉—CF₃); a cholesteryl radical or radicals derived from cholesterol (for example, cholesteryl hexanoate); aromatic polycyclic groups, for instance naphthalene or pyrene; and silicone or alkylsilicone or alkylfluorosilicone radicals. Among these radicals, linear and branched alkyl radicals are preferred.

The amphiphilic polymers may be water-soluble or water-dispersible in neutralized form.

The amphiphilic polymers may be crosslinked. The crosslinking agents may be chosen from, for example, the polyolefinically unsaturated compounds commonly used for crosslinking polymers obtained by free-radical polymerization. According to one preferred embodiment of the invention, the crosslinking agent is chosen from methylenebisacrylamide, allyl methacrylate or trimethylolpropane triacrylate (TMPTA). The degree of crosslinking preferably ranges from 0.01 mol % to 10 mol %, and preferably from 0.2 mol % to 2 mol %, relative to the polymer, including all ranges and subranges therebetween.

The amphiphilic polymers may be homopolymers or copolymers.

The amphiphilic polymers can be partially or totally neutralized with a mineral base (for example, sodium hydroxide, potassium hydroxide or aqueous ammonia) or an organic base such as monoethanolamine, diethanolamine, triethanolamine, aminomethylpropanediol, N-methylglucamine, or basic amino acids, for instance arginine and lysine, and mixtures thereof.

The amphiphilic polymers may be water-soluble or water-dispersible homopolymers such as, for example, optionally cross-linked polymers of sodium 2-acrylamido-2-methylpropane sulfonate acid such as that used in the commercial product SIMULGEL 800 (CTFA name: Sodium Polyacryloyldimethyl Taurate), cross-linked polymers of ammonium 2-acrylamido-2-methyl propane sulfonate acid (INCI name: AMMONIUM POLYACRYLDIMEHYLTAURAMIDE) such as the product sold under the tradename HOSTACERIN AMPS@ by Clariant.

The amphiphilic polymers may be chosen from crosslinked or non-crosslinked amphiphilic polymers of 2-acrylamido-2-methylpropanesulphonic (AMPS) acid and of at least one ethylenically unsaturated monomer comprising at least one hydrophobic portion containing from 6 to 30 carbon atoms, preferably from 6 to 22 carbon atoms, preferably from 6 to 18 carbon atoms and preferably from 12 to 18 carbon atoms, including all ranges and subranges therebetween.

Suitable examples of amphiphilic polymers include, but are not limited to, hydrophobically-modified sulfonic acid copolymers such as Ammonium Acryloyldimethyltaurate/VP Copolymer (Aristoflex AVC from Clariant), Ammonium Acryloyldimethyltaurate/Beheneth-25 Methacrylate Crosspolymer (Aristoflex HMB from Clariant) (crosslinked ethoxylated AMPS/behenyl methacrylate), Ammonium Acryloyldimethyltaurate/Steareth-25 Methacrylate Crosspolymer (Aristoflex HMS) (ethoxylated copolymer of AMPS/stearyl methacrylate crosslinked with trimethylol triacrylate), Aristoflex SNC (crosslinked ethoxylated AMPS/C16-C18), Aristoflex LNC (noncrosslinked AMPS/C12-C14), acrylamide/sodium acryloyldimethyl taurate copolymer/isohexadecane/polysorbate 80) (Simulgel 600) and mixtures thereof.

According to preferred embodiments, the gelling agent(s) may be at least one clay. Among the clays, mention may be made of clays of the smectite family, such as laponite, of the kaolinite family, such as kaolinite, dickite, nacrite, optionally modified clays of the halloysite, dombassite, antigorite, berthierine, pyrophyllite, montmorillonite, beidellite, vermiculite, talc, stevensite, hectorite, saponite, chlorite, sepiolite and illite family.

Clays are products that are already well known per se, which are described, for example, in the publication “Mineralogie des argiles” [“Clay Mineralogy”], S. Caillère, S. Hénin, M. Rautureau, 2nd Edition 1982, Masson, the teaching of which is included herein by way of reference.

Natural clay is a sedimentary rock composed to a large extent of specific minerals, silicates generally of aluminium. Kaolin is thus a natural clay.

The clays may also be synthetic. Thus, Sumecton mentioned below is a synthetic saponite.

Preferably, in the context of the present invention, use is made of clays that are cosmetically compatible and acceptable with keratin materials. Clays that may especially be mentioned include kaolinite, montmorillonites, saponites, laponites, hectorites, and illites. Mixtures of clays and natural clays may also be used.

Natural clays that may be mentioned include green clays, in particular rich in illite; clays rich in montmorillonite, known as fuller's earth, or such as bentonite or else white clays rich in kaolinite. As bentonites, mention may in particular be made of those sold under the names Bentone 38 VCG®, Bentone Gel CAO V®, Bentone 27 V® and Bentone Gel MIO V® by the company Elementis.

By way of clay rich in montmorillonite, mention may be made of the aluminium silicate hydrate sold under the name Gel White H® by the company Rockwood.

By way of saponite, which belongs to the montmorillonite family, mention may be made of synthetic saponite, in particular the product sold by the company Kunimine under the name Sumecton®.

By way of tack, mention may be made of those sold under the names Rose Talc® and Talc SG-2000® sold by the company Nippon Talc, Luzenac Pharma M® sold by the company Luzenac, J-68BC® from US Corporation and Micro ACE-P-3® sold by the company Nippon Talc.

Preferably, if present, the gelling agent(s) is/are present in the compositions of the present invention in amounts ranging from about 0.1 to about 30% by weight, preferably from 0.5 to 25% by weight, preferably from 1 to 20% and preferably from 2.5 to 15% by weight, all weights based on the weight of the composition as a whole, including all ranges and subranges therebetween such as, for example, 0.1 to 1.5%, 2 to 20%, 10 to 20%, etc.

### Colorant (Coloring Agent)

According to embodiments of the present invention, compositions optionally further comprising at least one coloring agent are provided. According to preferred embodiments, the at least one coloring agent, if present, is at least one surface-treated pigment. “Surface-treated pigment” means pigments that have totally or partially undergone a surface treatment of chemical, electronic, electrochemical, mechanochemical or mechanical nature, with a surface treatment agent. Preferably, the pigments are selected from inorganic pigments or inorganic/organic mixed pigments.

Surface treatment agents may be selected from the group consisting of alkyl silanes, organotitanates, halogenated phosphonates, and halogenated organosilanes. According to preferred embodiments, pigments have been surface treated with a surface treatment agent selected from the group consisting of alkoxylated alkyl silanes such as, for example, ethoxylated and/or propoxylated C2-C8 alkyl silanes, and salts thereof, organotitanates such as, for example, titanium salts of fatty acids such as, for example, C2-C8 alkylated titanium salts of C9-C24 fatty acids such as stearic acid, isostearic acid, oleic acid, cetearic acid, cetyl acid, etc., halogenated organophosphonates such as, for example, perfluoroalkyl phosphonates, and salts thereof, and halogenated organosilanes such as, for example, perfluoro C2-C8 alkyl silanes (optionally ethoxylated and/or propoxylated), and salts thereof. Specific examples of suitable surface treatment agents include (1) triethoxy caprylylsilane, (2) perfluorooctyltriethoxysilane, (3) sodium perfluorohexylethylphosphonate and (4) isopropyl titanium triisosterate.

Preferred surface treatment agents are selected from the group consisting of alkyl silanes and halogenated organosilanes. According to preferred embodiments, pigments have been surface treated with a surface treatment agent selected from the group consisting of alkoxylated alkyl silanes such as, for example, ethoxylated and/or propoxylated C2-C8 alkyl silanes, and salts thereof, and halogenated organosilanes such as, for example, perfluoro C2-C8 alkyl silanes (optionally ethoxylated and/or propoxylated), and salts thereof. Specific examples of suitable surface treatment agents include (1) triethoxy caprylylsilane, and (2) perfluorooctyltriethoxysilane.

The surface-treated pigments of the present invention can be prepared according to surface treatment techniques well known to a person of ordinary skill in the art or can be found commercially.

For example, the surface treatment agent with which the pigments are treated can be deposited on the pigments by solvent evaporation, chemical reaction between the molecules of the surface treatment agent or creation of a covalent bond between the surface treatment agent and the pigments. The surface treatment can thus be carried out, for example, by chemical reaction of a surface treatment agent with the surface of the pigments and creation of a covalent bond between the surface treatment agent and the pigments. An exemplary method is described, for example, in U.S. Pat. No. 4,578,266, the entire contents of which is hereby incorporated by reference.

The at least one surface-treated pigment, if present, preferably is present in the compositions of the present invention in an active solid content amount ranging from about 1% to about 30%, preferably from about 3% to about 25%, and preferably from about 5% to about 20%, by weight with respect to the total weight of the composition, including all ranges and subranges there between.

According to preferred embodiments of the present invention, compositions further comprising at least one unsurfaced-treated (not surface-treated) coloring agent are provided. Such coloring agents, if present, may be in addition to, or instead of, the surface-treated pigment discussed above.

According to this embodiment the coloring agent is preferably chosen from pigments which are not surface-treated, dyes, such as liposoluble dyes, nacreous pigments, and pearling agents.

Representative liposoluble dyes which may be used according to the present invention include Sudan Red, DC Red 17, DC Green 6, β-carotene, soybean oil, Sudan Brown, DC Yellow 11, DC Violet 2, DC Orange 5, annatto, and quinoline yellow. The liposoluble dyes, when present, generally have a concentration ranging up to 40% by weight of the total weight of the composition, such as from 0.0001% to 30%, including all ranges and subranges therebetween.

The nacreous pigments which may be used according to the present invention may be chosen from colored nacreous pigments such as titanium mica with iron oxides, titanium mica with ferric blue or chromium oxide, titanium mica with an organic pigment chosen from those mentioned above, and nacreous pigments based on bismuth oxychloride. The nacreous pigments, if present, be present in the composition in a concentration ranging up to 50% by weight of the total weight of the composition, such as from 0.0001% to 40%, preferably from 0.001% to 30%, including all ranges and subranges therebetween.

The non-surface treated pigments, which may be used according to the present invention, may be chosen from white, colored, inorganic, organic, polymeric, and nonpolymeric pigments. Representative examples of mineral pigments include titanium dioxide, zirconium oxide, zinc oxide, cerium oxide, iron oxides, chromium oxides, manganese violet, ultramarine blue, chromium hydrate, and ferric blue. Representative examples of organic pigments include carbon black, pigments of D & C type, and lakes based on cochineal carmine, barium, strontium, calcium, and aluminum.

If present, the coloring agents may be present in the composition in a concentration ranging up to 50% by weight of the total weight of the composition, such as from 0.0001% to 40%, and further such as from 0.001% to 30%, including all ranges and subranges therebetween.

According to preferred embodiments, the compositions of the present invention are devoid of, free of, or substantially free of, coloring agents.

### Active Agent

According to preferred embodiments of the present invention, compositions further comprising at least one active agent are provided. Preferably, the active agent is in the aqueous phase (hydrophilic active agent), although active agents may be present in the oil phase (hydrophobic active agent).

In some embodiments, the active agent may be:
a moisturizing agent, such as a polyol such as, for example, glycerin and sugars, urea and its derivatives, such as in particular hydroxyalkyl urea, in particular hydroxyalkylurea, and mixtures thereof;
a dequamating agent, which may be a compound capable of acting either directly on desquamation by promoting exfoliation, such as β-hydroxy acids, in particular salicylic acid and its derivatives (including 5-n-octanoylsalicylic acid); α-hydroxy acids, such as glycolic acid, citric acid, lactic acid, tartaric acid, malic acid or mandelic acid; urea; gentisic acid; oligofucoses; cinnamic acid; extract of Saphora japonica; resveratrol and certain jasmonic acid derivatives; or acting on the enzymes involved in the desquamation or degradation of corneodesmosomes, glycosidases, stratum corneum chymotryptic enzyme (SCCE), or even other proteases (trypsin, chymotrypsin-like). Mention may be made of agents for chelating mineral salts: EDTA; N-acyl-N,N′,N′-ethylenediaminetriacetic acid; aminosulfonic compounds and in particular (N-2-hydroxyethylpiperazine-N-2-ethane) sulfonic acid (HEPES); 2-oxothiazolidine-4-carboxylic acid (procysteine) derivatives; α-amino acid derivatives of the type such as glycine (as described in EP-0 852 949 and sodium methylglycinediacetate sold by BASF under the trade name Trilon M); honey; sugar derivatives such as O-octanoyl-6-D-maltose and N-acetylglucosamine;
a humectant;
an anti-aging agent, which may include, for example, one or more of C-beta-D-xylopyranoside-2-hydroxypropane (Pro-Xylane), retinol, peptides, caffeine, and other components that provide improvement to skin texture, any other suitable soluble/dispersible targeted active ingredient, and combinations thereof.
a mattifying agent, which may include, but is not limited to, mattifying fillers such as, for example, talc, silica, silicone elastomers, and polyamides, and waxes such as, for example, beeswax and Copernicia cerifera (carnauba) wax.
an antimicrobial agent, non-limiting examples of which include 2,4,4′-trichloro-2′-hydroxydiphenyl ether (or triclosan), 3,4,4′-trichlorobanilide, phenoxyethanol, phenoxypropanol, phenoxyisopropanol, hexamidine isethionate, metronidazole and its salts, micronazole and its salts, itraconazole, terconazole, econazole, ketoconazole, saperconazole, fluconazole, clotrimazole, butoconazole, oxiconazole, sulfaconazole, sulconazole, terbinafine, ciclopirox, ciclopiroxolamine, undecylenic acid and its salts, benzoyl peroxide, 3-hydroxybenzoic acid, 4-hydroxybenzoic acid, phytic acid, N-acetyl-L-cysteine acid, lipoic acid, azelaic acid and its salts, arachidonic acid, resorcinol, 2,4,4′-trichloro-2′-hydroxydiphenyl ether, 3,4,4′-trichlorocarbanalide, octopirox, octoxyglycerine, octanoyiglycine, caprylyl glycol, 10-hydroxy-2-decanoic acid, dichlorophenylimidazole dioxolane and its derivatives described in patent WO 93/18743, farnesol and phytosphingosines, and mixtures thereof;
a pigment modifying agent and/or skin lightening agents, such as double-stranded RNA oligonucleotides are useful for decreasing tyrosinase expression. Mention may also be made of ceramides, vitamin C and derivatives thereof, in particular vitamin CG, CP and 3-O ethyl vitamin C, alpha- and beta-arbutin, ferulic acid, kojic acid, resorcinol and derivatives thereof, calcium D-pantetheine sulphonate, lipoic acid, ellagic acid, vitamin B3, phenylethyl resorcinol, for instance Symwhite 377® from the company Symrise, a kiwi fruit (Actinidia chinensis) juice sold by Gattefosse, an extract of Paeonia suffructicosa root, such as the product sold by the company Ichimaru Pharcos under the name Botanpi Liquid B®, an extract of brown sugar (Saccharum officinarum), such as the extract of molasses sold by the company Taiyo Kagaku under the name Molasses Liquid, a mixture of undecylenic acid and undecylenoyl phenyl alanine, such as Sepiwhite MSH® from Seppic;
a vitamin such as a vitamin A compound such as retinol or retinoic acid, vitamin B compound such as vitamin B1, B3 or B6, a vitamin C compound such as an ascrobyl phosphate salt (e.g., magnesium or sodium, and/or derivatives thereof;
an ultraviolet (UV) filter such as, e.g., an aminobenzoic acid derivative, a dibenzoylmethane derivative, a salicylic acid derivative, a cinnamic derivative, a β,β diphenylacrylate derivative, a benzophenone derivative, benzylidene camphor derivative, and mixtures thereof. Mention may be made especially of ethylhexyl methoxycinnamate sold under the tradename UVINUL MC 80® by the company BASF, of ethylhexyl salicylate sold under the tradename NEO HELIOPAN OS® by the company SYMRISE and of octocrylene sold under the tradename NEO HELIOPAN 303® by the company SYMRISE; and/or a combination thereof.

According to certain embodiments, compositions of the present invention include at least two of gelling agent, colorant and active agents.

### Additional Additives

The composition of the invention can also comprise any additive usually used in the field under consideration. For example, additional film forming agents (in addition to hydrophobically-modified polysaccharide compound and aqueous phase film former), waxes, dispersants such as poly(12-hydroxystearic acid), preserving agents, fragrances, fillers, antioxidants, neutralizing agents, silicone elastomers, and mixtures thereof can be added. A non-exhaustive listing of such ingredients can be found in U.S. patent application publication no. 2004/0170586, the entire contents of which is hereby incorporated by reference. Further examples of suitable additional components can be found in the other references which have been incorporated by reference in this application. Still further examples of such additional ingredients may be found in the International Cosmetic Ingredient Dictionary and Handbook (9^{th} ed. 2002). However, it is to be understood that preferred embodiments of the present invention include compositions which are “free,” substantially free” or “devoid” of the ingredients discussed in this paragraph such as additional film forming agents and waxes.

According to preferred embodiments, the compositions of the present invention contain a total solids content (excluding film formers) of 10% by weight or less, preferably 5% by weight or less, or preferably 3% by weight or less based on the weight of the composition. Preferably, compositions of the present invention are devoid of, free of, or substantially free of, solids (excluding film formers).

A person skilled in the art will take care to select the optional additional additives and/or the amount thereof such that the advantageous properties of the composition according to the invention are not, or are not substantially, adversely affected by the envisaged addition.

These substances may be selected variously by the person skilled in the art in order to prepare a composition which has the desired properties, for example, consistency or texture.

Needless to say, the composition of the invention should be cosmetically or dermatologically acceptable, i.e., it should contain a non-toxic physiologically acceptable medium and should be able to be applied to keratinous material of human beings.

According to preferred embodiments of the present invention, methods of caring for, and/or making up, keratinous material by applying compositions of the present invention to the keratinous material in an amount sufficient to care for, and/or to make up, the keratinous material are provided. Similarly, preferred embodiments of the present invention include methods of priming keratinous material for a cosmetic composition and/or of setting a cosmetic composition which has been previously applied to keratinous material by applying compositions of the present invention over keratinous material prior to application of a cosmetic composition (priming) and/or by applying compositions of the present invention over a cosmetic composition previously-applied to keratinous material (setting). Preferably, the cosmetic composition used in conjunction with compositions of the present invention is a color cosmetic composition.

Preferably, “making up” the keratin material includes applying at least one coloring agent to the keratin material (in either the composition itself or in a color coat composition applied either over or under the composition as described above) in an amount sufficient to provide color to the keratin material.

According to particularly preferred embodiments of the present invention, methods of making up keratinous material such as skin comprising (1) applying a color cosmetic composition such as a foundation to the keratinous material (e.g., skin), (2) allowing the color cosmetic composition to dry on the keratinous material (e.g., skin), preferably allowing it to dry for about 1 minute to about 15 minutes, preferably for about 5 minutes to 10 minutes, and (3) applying a composition of the present invention over the dried color cosmetic composition which has been applied to keratinous material (e.g., skin) are provided. Preferably, compositions of the present invention are applied over the dried color cosmetic composition in an amount sufficient to improve transfer resistance of the color cosmetic composition as compared to the transfer resistance provided by the color cosmetic composition when applied to keratinous material by itself.

According to certain preferred embodiments, a method of making up the skin includes applying a composition of the present invention to skin having a makeup film formed thereon. The makeup film may result from, for example, applying a foundation or other first makeup composition such as one including a coloring agent being applied to the skin and optionally being allowed to dry, such as by waiting for a time period described in the paragraph above. The composition of the present invention includes (a) water, (b) at least one oil, (c) at least one organosilicone polymer selected from a silicone acrylate copolymer, a glycerolated silicone resin and combinations thereof; and (d) at least one aqueous phase film former. In this embodiment, the composition of the present invention acts as a makeup setter.

Compositions of the present invention may be applied by spraying or rubbing with a pad or applicator.

According to preferred embodiments of the present invention, kits comprising, as separate compositions in one or more containers within the kits, (A) at least one composition of the present invention, in particular a setter or primer composition for cosmetics, comprising at least one hydrophobically-modified polysaccharide compound and at least one aqueous phase film former; and (B) at least one other composition such as a cosmetic composition comprising at least one colorant are provided.

Compositions (A) and (B) may be contained in different portions or sections of the same container within the kit. However, compositions (A) and (B) may also be in different containers with the kit.

According to preferred embodiments of the present invention, sets, as applied onto keratinous material, comprising (A) at least one first layer of at least one composition comprising at least one colorant; and (B) at least one second layer of at least one composition of the present invention, in particular a setter or primer composition for cosmetics, comprising at least one hydrophobically-modified polysaccharide compound and at least one aqueous phase film former are provided. Preferably, the at least one second layer is applied over the at least one first layer (in which case the second layer is a setter layer formed by application of a setter composition to the first layer). However, if the at least one first layer is applied over the at least one second layer, the at least one second layer is a primer layer formed by application of a primer composition over keratinous material.

According to a preferred embodiment of the present invention, compositions having improved cosmetic properties such as, for example, increased water-resistance, sebum-resistance and/or transfer-resistance are provided. Preferably, the composition is a composition for skin. Most preferably, the composition is a setter or primer composition. Also preferably, the composition further comprises at least one gelling agent and/or at least one active agent.

According to a preferred embodiment of the present invention, methods of making oil-in-water (o/w) emulsions (compositions) of the present invention comprising combining at least one hydrophobically-modified polysaccharide compound and at least one aqueous phase film former in the amounts and/or ratios discussed above during formation of the emulsion composition are provided. Preferably, the composition is a composition for application to skin. Most preferably, the composition is a setter or primer composition, and/or is in the form of a gel. Also preferably, the composition further comprises at least one gelling agent and/or at least one active agent.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective measurements. The following examples are intended to illustrate the invention without limiting the scope as a result. The percentages are given on a weight basis.

### EXAMPLES

### Example 1—Sample Inventive Compositions

Example inventive compositions are given in Table 3 below.

TABLE 3

| | Total %100.00 - | Total 100% - |
|---|---|---|
| | General | Preferred |
| Chemical Name/Function | % wt/wt | % wt/wt |
| Surfactants | 0-10% | 0.1-3% |
| Aqueous Phase Film | 0.5-20% | 1-10% |
| Former | | |
| silicone acrylate | 0.5-20% | 1-10% |
| copolymer and/or | | |
| glycerolated silicone resin | | |
| Oils | 1-30% | 2-10% |
| Colorant/fragrance/active | Optional | Substantially free |
| Water | QS | QS |
| Monoalcohol | 0-30% | 2.5-25% |
| Gelling Agent | 0.1-10% | 0.1-3% |

### Example 2—Testing Protocol—Transfer Resistance

(Dry) Transfer resistance can be determined as follows.

A color cosmetic composition (e.g., foundation such as L'Oreal Paris Makeup True Match Liquid Foundation) is applied on keratinous material (e.g., skin) in a controlled amount (e.g., 0.020 gram) in a controlled area (e.g., 3 cm×3 cm square). Allow 5-15 minutes until the composition has dried.

Apply a test composition (setter) in a controlled amount (e.g., the same amount as was applied of the color cosmetic composition, such as 0.020 gram) over the applied color cosmetic composition and allow it to dry.

A white cotton ball/pad swatch is then used to rub across the area an identified number of times (for example, 5 times or more) to assess transfer resistance of color cosmetic composition to the ball/pad swatch after such rubbing. Transfer resistance can be evaluated by determining the difference in the amount of color cosmetic composition transferred to the cotton ball/pad swatch, with or without the applied setting composition. Transfer resistance is evaluated on a 1 to 5 scale, with 1=minimal improvement in transfer resistance of color cosmetic composition to the cotton ball/pad swatch; 3=medium improvement in transfer resistance of color cosmetic composition to the cotton ball/pad swatch; and 5=large improvement in transfer resistance of color cosmetic composition to the ball/pad swatch, with little or no transfer of color cosmetic composition to the cotton ball/pad swatch occurring.

### Example 3—Testing Protocol—Water Resistance

Water resistance can be determined as follows. A color cosmetic composition (e.g., foundation such as L'Oreal Paris Makeup True Match Liquid Foundation) is applied on keratinous material (e.g., skin) in a controlled amount (e.g., 0.020 gram) in a controlled area (e.g., 3 cm×3 cm square). Allow 5-15 minutes until the composition has dried.

Apply a test composition (setter) in a controlled amount (e.g., the same amount as was applied of the color cosmetic composition, such as 0.020 gram) over the applied color cosmetic composition and allow it to dry.

Put the keratinous material (e.g., skin) under water. Rubbing the area with palm (for example, 5 times or more). Dry the area before conducting the evaluation.

The water resistance can be evaluated by the difference in the color before and after the in water rubbing test. Water resistance is evaluated on a 1 to 5 scale, with 1=some color change after the rubbing test with water; 3=slight color change after the rubbing test with water; and 5=no color change after the rubbing test with water.

The following compositions: inventive examples Ex 1, Ex 2, as well as comparative examples C1 and C2 were prepared and tested as setter compositions for L'Oreal Paris Makeup True Match Liquid Foundation per the protocol in Examples 2 and 3.

Comparative examples C1 and C2 included no silicone acrylate copolymer and no glycerolated silicone resin.

Examples Ex 1 and Ex 2 were representative of the invention compositions containing silicone acrylate copolymer or glycerolated silicone resin.

Transfer resistance of the commercial foundation+prepared setter compositions was determined per the protocol in example 2. Specific test compositions and test results are shown in Tables 4 and 5 below.

TABLE 4

| | Ex 1 | Ex 2 |
|---|---|---|
| Glycerin-modified MQ Resin (50% in | 5 | |
| isododecane) | | |
| Acrylates/Polytrimethylsiloxymethacrylate | | 5 |
| Copolymer(40% in isododecane) | | |
| Isohexadecane | 0.32 | 0.32 |
| Sorbitan Oleate | 0.04 | 0.04 |
| Polysorbate 80 | 0.10 | 0.10 |
| Sodium acrylate/sodium acryloyldimethyl | 0.60 | 0.60 |
| taurate copolymer | | |
| Vinyl pyrrolidone/Methacrylamide/Vinyl | 6.25 | 6.25 |
| Imidazole Copolymer (20% in water) | | |
| Ethanol | 25 | 25 |
| water | QS | QS |
| Oil phase film former | 2.5 | 2 |
| Water phase film former | 1.25 | 1.25 |
| Total film former | 3.75 | 3.25 |
| Transfer test - Water Resistance | 1 | 1 |
| Transfer test - Dry Transfer | 2 | 3 |

TABLE 5

| | C1 | C2 |
|---|---|---|
| Glycerin-modified MQ | 0 | |
| Resin (50% in isododecane) | | |
| Acrylates/ | | 0 |
| Polytrimethylsiloxymethacrylate | | |
| Copolymer(40% in isododecane) | | |
| Isododecane | 2.00 | 5.00 |
| Isohexadecane | 0.32 | 0.32 |
| Sorbitan Oleate | 0.04 | 0.04 |
| Polysorbate 80 | 0.10 | 0.10 |
| Sodium acrylate/sodium | 0.60 | 0.60 |
| acryloyldimethyl | | |
| taurate copolymer | | |
| Vinyl pyrrolidone/ | 6.25 | 12.5 |
| Methacrylamide/ | | |
| Vinyl Imidazole Copolymer | | |
| (20% in water) | | |
| Ethanol | 25 | 25 |
| Water | QS | QS |
| Oil phase film former | 0 | 0 |
| Water phase film former | 1.25 | 2.5 |
| Total film former | 1.25 | 2.5 |
| Transfer test - | No | No |
| Water Resistance | improvement | improvement |
| Transfer test - | 1 | 3 |
| Dry Transfer | | |

As can be seen, setter compositions corresponding to the present invention resulted in water resistance when used in conjunction with the commercial foundation product as compared to the comparative setter compositions containing no silicone acrylate copolymer or glycerolated silicone resin.

What is claimed is:

1. An oil-in water emulsion composition comprising (a) water, (b) at least one oil, (c) at least one organosilicone polymer selected from a silicone acrylate copolymer, a glycerolated silicone resin and combinations thereof; and (d) at least one copolymer comprising a vinyl pyrrolidone monomer.

2. The composition of claim 1 wherein the at least one copolymer comprising a vinyl pyrrolidone monomer is a copolymer of N-vinyl pyrrolidone, methacrylamide, and N-vinylimidazole.

3. The composition of claim 1, in the form of a gel.

4. The composition of claim 1, wherein the composition further comprises (e) at least one compound selected from the group consisting of at least one gelling agent, at least one colorant, at least one active agent, and mixtures thereof.

5. The composition of claim 4, wherein at least two of gelling agent, colorant and active agent are present in the composition.

6. The composition of claim 1, wherein the at least one organosilicone polymer is a silicone acrylate copolymer.

7. The composition of claim 1, wherein the at least one organosilicone polymer is a glycerolated silicone resin.

8. The composition of claim 1, wherein the (c) at least one organosilicone polymer selected from a silicone acrylate copolymer, a glycerolated silicone resin and combinations thereof; and the (d) at least one copolymer comprising a vinyl pyrrolidone monomer are present in a weight ratio, (c):(d) that is from about 0.5:1 to about 3:1.

9. The composition of claim 1, wherein the composition is devoid of colorant.

10. A method of making up skin comprising applying a composition to skin having a makeup film formed thereon, wherein the composition comprises (a) water, (b) at least one oil, (c) at least one organosilicone polymer selected from a silicone acrylate copolymer, a glycerolated silicone resin and combinations thereof; and (d) at least one aqueous phase film former.

11. The method of claim 10, wherein the at least one aqueous phase film former is selected from a group consisting of polyvinylpyrrolidone, vinylpyrrolidone/vinyl acetate copolymer, vinylpyrrolidone/acrylic acid copolymer, polyvinyl alcohol, copolymer of N-vinyl pyrrolidone, methacrylamide, and N-vinylimidazole.

12. The method of claim 10, wherein the at least one aqueous phase film former is a copolymer comprising a vinyl pyrrolidone monomer.

13. The method of claim 10, wherein the composition of claim 1 is in the form of a gel.

14. The method of claim 10, wherein the composition further comprises (e) at least one compound selected from the group consisting of at least one gelling agent, at least one colorant, at least one active agent, and mixtures thereof.

15. The method of claim 14, wherein at least two of gelling agent, colorant and active agent are present in the composition.

16. The method of claim 10, wherein the at least one organosilicone polymer is a silicone acrylate copolymer.

17. The method of claim 10, wherein the at least one organosilicone polymer is a glycerolated silicone resin.

18. The method of claim 10, wherein the (c) at least one organosilicone polymer selected from a silicone acrylate copolymer, a glycerolated silicone resin and combinations thereof; and the (d) at least one aqueous phase film former are present in a weight ratio, (c):(d) that is from about 0.5:1 to about 3:1.
